(19) United States
(12) Patent Application Publication
(10) Pub. No.: US 2008/0170928 A1
(43) Pub. Date: Jul. 17, 2008

(54) FASTENING ELEMENT FOR INSERTING INTO AN OPENING

(75) Inventors: Roger Stadler, St. Gallen (CH); Bekim Bajramaj, Balgach (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SEPITEC FOUNDATION, Vaduz (LI)

(21) Appl. No.: 12/024,210

(22) Filed: Feb. 1, 2008

Related U.S. Application Data
(63) Continuation of application No. PCT/EP2006/007445, filed on Jul. 27, 2006.

(30) Foreign Application Priority Data
Aug. 1, 2005 (DE) 102005036110.2

(51) Int. Cl. F16B 39/284; F16B 35/00

(52) U.S. Cl. 411/392; 411/548

(57) ABSTRACT

A fastening element (1) to be inserted into an opening, or bore (2) of a work piece (3) is provided having a shaft (5) that is insertable into the bore (2) and has a roughened and/or profiled surface (4), and optionally includes a stop collar (6). The fastening element (1) is preferably formed from a fiber reinforced, elastically deformable material, and its shaft (5) can be or is inserted into the bore (2) in a force-fitting manner under an elastic deformation.

### CROSS-REFERENCE TO RELATED APPLICATIONS

This application is a continuation of PCT/EP2006/007445, filed Jul. 26, 2006, which claims the benefit of DE 10 2005 036 110.2, filed Aug. 1, 2005, both of which are incorporated herein by reference as if fully set forth.

### BACKGROUND OF THE INVENTION

The invention relates to a fastening element to be inserted into a bore, which is provided with a shaft having a roughened and/or profiled surface and optionally a stop collar and can be inserted into a bore.

Such fastening elements are known, for example, from WO03/042551A2 or US2005/0025606A1. These fastening elements are made from a plastically deformable material, with the roughened and/or profiled shaft being inserted into the bore of a work piece. After the insertion, a bolt or a helical body is pulled or pushed through the opening in the shaft, which causes a plastic deformation of the shaft and generally also the wall of the bore in the work piece. The exterior wall of the roughened and/or profiled shaft of the fastening element then engages the wall of the bore in a form-fitting manner. Although here instead of the previously necessary two blind rivets for fastening a rivet nut only one riveting process is necessary for the shaft itself, appropriate deforming elements are still necessary and thus also particularly for the intended tension and/or pressure elements for the bolt or sphere etc. to be pulled or pushed through for deforming the shaft.

### SUMMARY OF THE INVENTION

The present invention therefore has the object to provide a fastening element of the type noted at the outset, which can be inserted without any additional parts for a plastic deformation and in spite thereof provides the necessary stability values when inserted into work pieces made from different materials.

According to the invention, this is attained by a fastening element that is inserted into an opening or bore, which is provided with a shaft, having a roughened and/or profiled surface that can be inserted into the bore, with the fastening element being provided with an elastically deformable material, preferably being made therefrom, and the shaft of the fastening element can be or is inserted in the bore in a form-fitting manner under an elastic deformation.

By this measure an optimal fastening of the fastening element in a work piece is achieved so that the elements to be fastened by the fastening element also enjoy a particularly good fastening. By this type of mutual connection of the fastening element and the work piece it is ensured that this connection is not loosened even after an extended period of use, because by the elastic deformation an appropriate compression force is always provided. A constant formfitting elastic connection is given, so that it can be called a “spring-connection”. Additionally, an essential advantage results from the fastening element contributing to an absorption of vibration.

An advantageous embodiment of the fastening element is provided in that it is preferably formed from a fiber-reinforced plastic. Using a fastening element embodied in such a fashion, the elastic deformation and a constant form-fitting connection can be ensured. Additionally, an essential weight reduction is given. The absorption features are optimal and additionally an excellent isolation effect is achieved, which is particularly advantageous when the mutual electric isolation is necessary.

One exemplary embodiment provides for the shaft to be embodied solid. This is recommended when particularly large axial pull-out forces are necessary. Then, the entire solid cross-section of the shaft is effective for the elastic form-fitting connection.

Another exemplary embodiment provides that the shaft is embodied with a tubular profile. In this manner the fastening element can also be used for additional uses in the area of the shaft due to the central penetrating opening.

It must be considered particularly advantageous that the shaft is provided at its exterior surfaces with ribs, flutes, knobs, corrugations, and/or teeth. The force-fitting connection can be improved even more in that these surface structures can deform elastically in all directions so that thus an optimal force-fitting connection can be achieved to the wall of the bore in the work piece.

One variant of the embodiment provides that the exterior surface of the shaft is embodied with ribs, extending at least almost parallel to the central axis of the shaft, having flutes or corrugations embodied perpendicular in reference thereto to form a type of gearing. This improves the sectional or punctual compression even further and prevents any loosening of the shaft in the axial direction or any rotation in reference to the work piece.

Another embodiment variant provides that the ribs or knobs or corrugations or teeth protrude in the radial direction to a different extent. This way zones with a stronger and a weaker elastic compression are created, so that an optimal introduction of force is given from the fastening element to the work piece.

Another advantageous embodiment provides that one or several narrow ribs each provided perhaps with gearing or corrugations and one or more wider ribs perhaps also provided with gearing or corrugations alternating follow each other over the perimeter of the shaft. This also contributes to the formation of zones with different strength elastic compression.

Another design provides that several axially parallel aligned ribs are formed, with ribs being provided between some of such ribs extending in the circumferential direction of the shaft. This results in a particular fastening strength both in the axial direction of the shaft as well as the circumferential direction thereof because the elastic compression is distributed appropriately.

In order to further reduce the necessary force for the initial elastic deformation and in spite thereof ensuring sufficient mutual support for the final placement of the fastening element between the shaft and the wall of the bore in the work piece it is suggested for the knobs to be embodied in the form of pyramids or cones and/or faceted or round frustum-shaped elements.

Further it is suggested that the ribs, groove, knobs, corrugations, and/or teeth taper off at least at the edge regions of the shaft in an acute angle. This allows a much easier insertion of the shaft of the fastening element into the bore of the work piece. The pressure necessary for a subsequent insertion is then to be used fully for the placement of the fastening element so that after the placement the optimal elastically effective force-fitting connection can be achieved.

Another variant of the embodiment provides that at the shaft, in addition of the ribs, grooves, knobs, corrugations, and/or teeth one or more circumferential ribs, grooves, or the like are embodied, with the diameter measured at the bottom of the ribs and/or grooves being smaller than the diameter of the bore in the work piece, into which the shaft is to be inserted. This provides a particular safety against de-lamination because the contacting surface between the shaft and the bore in the work piece is reduced. This feature is not only to be embodied for thin-walled structures and/or work pieces but equally advantageous for thicker work pieces.

Another embodiment of a fastening element provides that a cage-like holder is connected to the stop collar to accept a threaded nut or a bolt head. The fastening element can also be used to hold additional fasteners, particularly because the fastening element itself is connected sufficiently to the work piece in an elastic formfitting manner.

Additional design possibilities result from the fastening element according to the invention. For example, one embodiment provides for a threaded sheath to follow the stop collar in one piece at the side opposite the shaft.

Another embodiment provides that at the stop collar, at the side opposite the shaft, a bolt follows in one piece aligned to the same shaft of the bolt. This bolt can provide for various purposes and fastening possibilities.

One embodiment provides for a threaded bolt following the stop collar in one piece at the side opposite the shaft having the same axis as the shaft. Thus, the fastening element itself is provided with a threaded bolt, by which many potential connections can be established.

### BRIEF DESCRIPTION OF THE DRAWINGS

The features according to the invention and particular advantages are explained in greater detail in the following description of the drawings. The drawing show:

FIG. 1 a view of a fastening element inserted in a work piece, with the work piece being shown in a cross-section;

FIG. 2 a view of the fastening element from the side;

FIG. 3 a top view of the fastening element;

FIGS. 4 and 5 perspective views of the fastening element;

FIGS. 6, 7, 8 various perspective representations of a second embodiment of the fastening element;

FIG. 9 a view of the fastening element according to FIGS. 6, 7, and 8 from the bottom;

FIG. 10 a side view of a third embodiment of the fastening element;

FIG. 11 a view of the fastening element according to FIG. 10 form the top;

FIG. 12 a view of the fastening element inserted in a work piece according to FIGS. 10 and 11, with the work piece being shown cross-sectioned;

FIGS. 13, 14 two perspective representations of a fastening element according to FIGS. 10 to 12;

FIG. 15 a view of an embodiment of the invention, in which the fastening element has an axial length greater than the thickness of the work piece or equivalent to thin-walled structures;

FIG. 16 a view of an embodiment of the invention, in which the shaft is additionally provided with a circular groove, which during the elastic deformation of the shaft is distanced from the wall of the bore in a work piece, even after deformation.

### DETAILED DESCRIPTION OF THE PREFERRED EMBODIMENTS

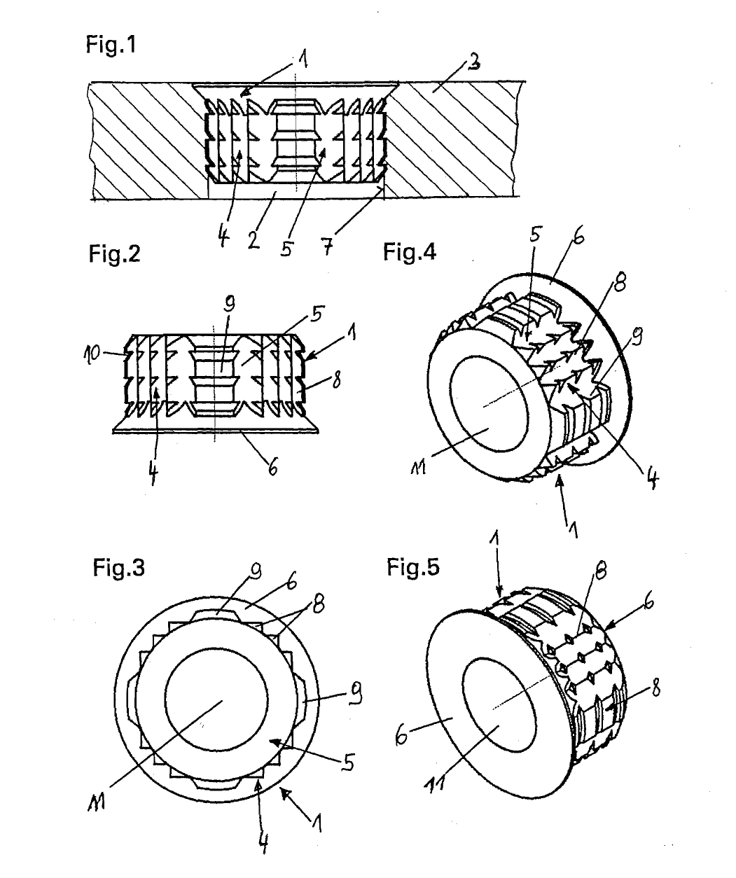

In FIGS. 1 through 5, a fastening element 1 is shown that is insertable into an opening, or bore 2 of a work piece 3, and is provided with a shaft 5 that can be inserted into the bore 2 that has a roughened and/or profiled surface and which perhaps has a stop collar 6. The fastening element 1 is formed from a preferably fiber-reinforced elastically deformable material. The shaft of the fastening element is inserted or can be inserted into the bore 2 in a force-fitting manner under elastic deformation. Here it is provided to use an also fiber-reinforced plastic. Within the scope of the invention various plastic materials or plastic-like materials can be used. It only must be ensured that the fastening element can be elastically deformed so that always a force-fitting connection can be achieved between the shaft 5 and the wall 7 of the bore 2 in the work piece 3. However, it is also possible to produce the work piece itself or both the work piece 3 and the fastening element 1 from an elastically deformable material, namely advantageously from a fiber-reinforced plastic.

The shaft 5 can be provided as a solid profile or as a tubular profile. This may be a cylindrical profile or profiles with various, cross-sectional shapes adjusted to the application. Particularly in case of a cross-sectional shape differing from the cylindrical form, in addition to the force-fitting contact when the fastening element is inserted, a form-fitting contact can be achieved in order to create the possibility to transfer respectively higher torque. Here, in case of a hollow profile the cross-section of the penetrating opening can be embodied with the same or a different form in reference to the cross-section of the exterior limit of the profile. In order to create an optimal compression and thus a force-fitting connection it is advantageous for the shaft 5 to be provided with ribs 8, 9, grooves, knobs, corrugations, and/or teeth at its exterior surface 4.

Here, at the exterior surface 4 of the shaft 5, ribs 8 can be provided, extending at least almost parallel in reference to the central axis of the shaft 5, with grooves 10 extending essentially perpendicular in reference thereto to form a type of gearing. The ribs 8 or knobs or teeth protrude different distances in the radial direction. One embodiment variant provides here to embody one or more narrow ribs 8 perhaps having teeth and one or more wider ribs 9 perhaps having teeth, alternating over the perimeter of the shaft 5, following each other. Therefore, an essentially uneven surface is provided, which allows an elastic deformation of the shaft and thus provides a force-fitting support of this area at the wall of the bore. Thus, forms other than ribs or corrugations can be provided, ergo any type of protruding domes. It is not always necessary for a type of undercut to be provided.

One embodiment is also discernible, here: several ribs 8 are provided, aligned axially parallel, with ribs 9 being provided between some of these ribs 8, extending in the circumferential direction of the shaft 5.

Within the scope of the invention it is also possible to provide elements in faceted or round frustum-like forms and/or pyramid or cone-shaped elements instead of ribs or even in addition to ribs. Further, it is advantageous when the ribs 8, 9, grooves, knobs, corrugations, and/or teeth taper towards the end in an acute angle at least at the end region of the shaft. This allows a facilitated insertion of the shaft 5 into the bore 2 at the work piece 3.

The fastening element 1 is inserted from one side of the work piece into the bore 2 in the work piece 3, with naturally a respective force being necessary to allow the respective elastic deformation of the ribs 8, 9, grooves, knobs, and/or teeth or corrugations. In order to insert the fastening element into the work piece a placement device can be used, which engages the work piece only from one side or from both sides and perhaps operates with counter fasteners. After the final placement of the fastening element, an optimal force-fitting connection is created between the exterior limit 4 of the shaft 5 and the wall 7 of the bore 2, which does not weaken even after an extended period of time inserted. By the elastic connection a constant compression is ensured which cannot be influenced even by shock, vibration, or changes in temperature. Even when the fastening material or the work piece is formed from materials with different expansion coefficients no dissolution of the connection can develop.

The fastening element according to the invention can therefore be used advantageously everywhere a particularly secure fastening is necessary, thus particularly in airplane construction and in vehicle design in general. Of course, the use in machine construction or electro-technology is also possible, as well as in the chemical field.

In the embodiment according to FIGS. 1 through 5, it is beneficial to provide the penetrating opening 11 with a thread, so that here threaded elements, such as e.g., bolts, can be inserted directly.

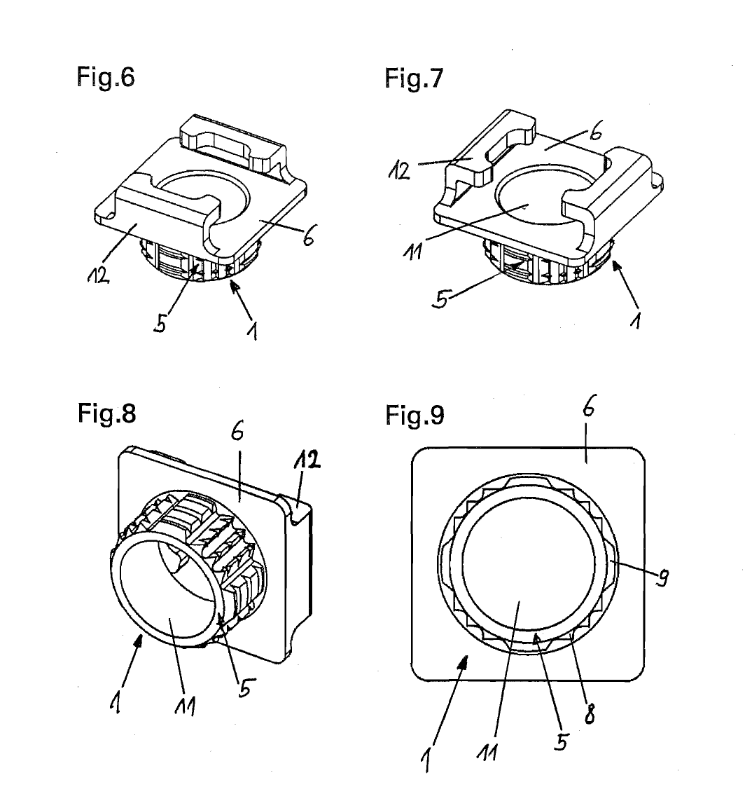

In an embodiment according to FIGS. 6 through 9, a stop collar 6 is provided with a cage-like holder 12 following to accept a mobile threaded nut or a bolt head. Therefore, here additional fastening parts can be used in a form-fitting manner, which then are protected from rotation and also from being pulled out in the axial direction. Due to the particular design possibilities of a plastic part, no additional clamps are necessary in the construction according to the invention to hold additional fastening parts. Particularly in such a fastening element, the invention allows to omit both the otherwise usual deformation element for the passive deformation as well as a clamp for holding additional fastening elements.

Within the scope of the invention, instead of a cage-like holder, a threaded sheath can be connected at the stop collar 6 in one piece at the side opposite the shaft 5. However, it is also possible to provide any other particular constructive solution. For example, here hooks, lugs, push buttons, and the like can be embodied in one piece with the fastening element.

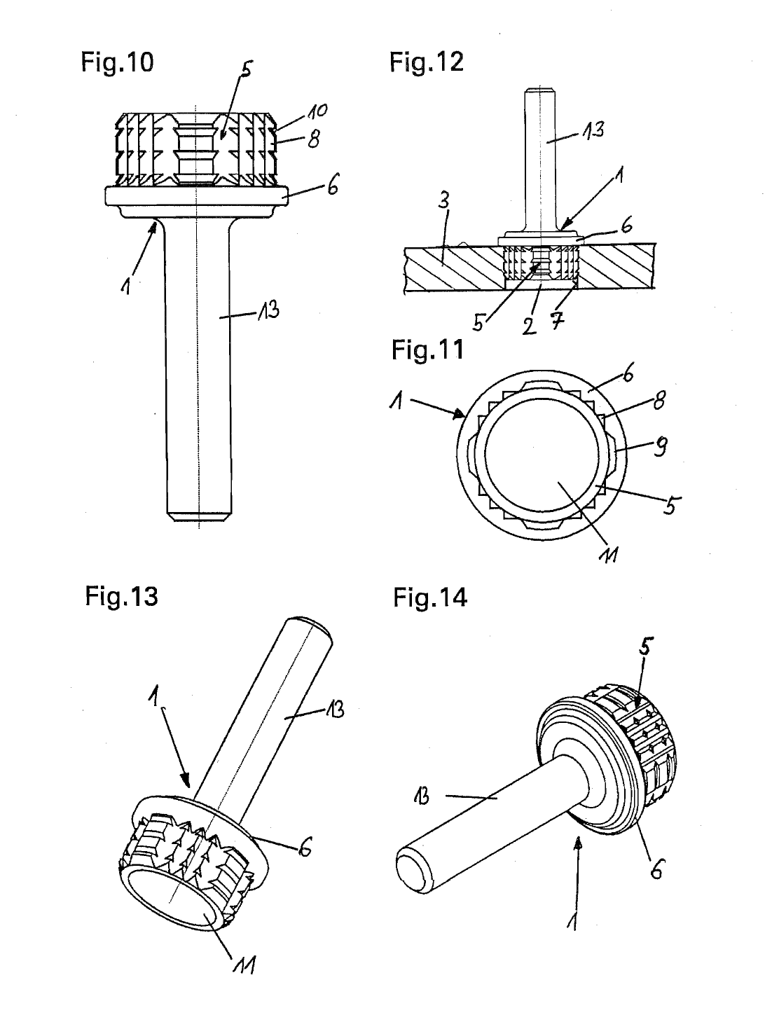

In the embodiment according to FIGS. 10 through 14, a fastening element 1 is provided in which a bolt 13 follows the stop collar 6 in one piece at the opposite the side of a shaft 5, aligned to the axis of the shaft 5. In an advantageous manner this bolt 13 is provided as a threaded bolt, so that other parts can be fastened directly thereto, for example by a nut.

In the embodiment according to FIG. 15, it is shown how the fastening element 1 according to the invention can also be used particularly advantageously in relatively thin work pieces 3. Here, an overlapping develops in the top regions of the work piece, so that particularly in thin-walled structures the fixation of the fastening element is supported. Additionally here, at the top of the fastening element, i.e. at the stop collar 6 or instead of the stop collar, a plate-shaped or disc-shaped stop 14 can be provided in order to ensure additional bending or tearing stability. A penetrating opening may be provided in the shaft 5, of course, optionally having a thread. Due to the fact that the shaft 5 of the fastening element has an axial length greater than the thickness of the work piece 3, a section 16 of the shaft 5 protruding on the back 15 of the work piece 3 can re-expand elastically after the elastic compression inside the bore of the work piece 3. The retention of the fastening element 1 is therefore particularly good in thin-walled structures, i.e. in thin work pieces 3. The constructive purpose for use shown here in FIG. 15 can also be used in the embodiments according to FIGS. 1 through 14. Even in these other structures, particularly in thin-walled structures, a fastening from one side has been achieved which previously was impossible.

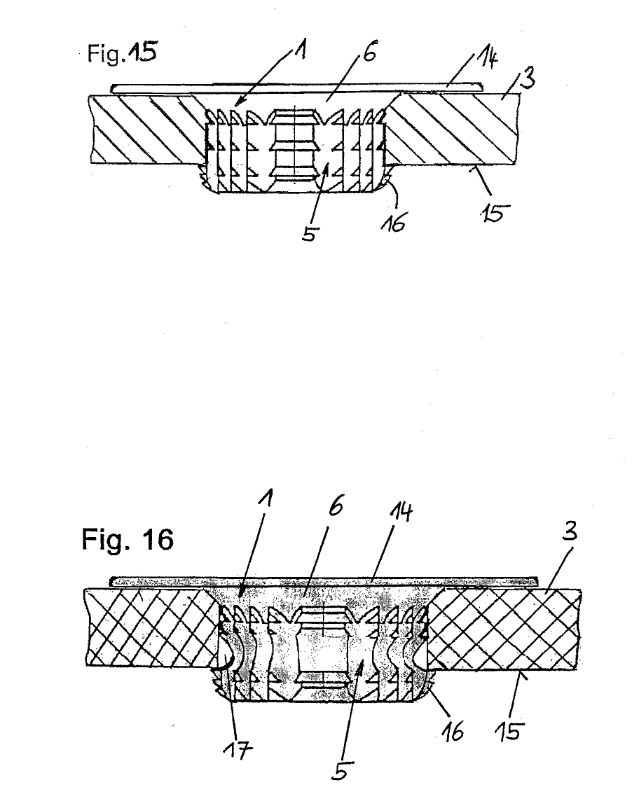

In the embodiment according to FIG. 16, at the shaft 5, a groove 17 encircling the perimeter is provided, which is here embodied at the end zone of the shaft 5 in order to reduce the contact surface between the wall of the bore in the work piece 3 and the shaft. Particularly in this area the friction force is reduced when placing the fastening element. Particularly when inserting the fastening element into a work piece made from a composite structure it can be prevented that the last layer splits off when the shaft 5 is pressed in. The groove 17 may also be arranged at a different position in reference to the axial length of the shaft 5 when at another location a specific zone is given, in which the friction shall be reduced during the placement of the fastening element. Within the scope of the invention it is also possible to arrange more than one groove 17 on the axial length of the shaft 5. Here, it is also possible that this groove 17 and/or grooves is or are, respectively, arranged not precisely circular in one plane. It would also be possible to provide a groove 17 helically encircling the perimeter of the shaft. Here, it can then also be provided during the placement process to support the insertion by a rotational process.

Within the scope of the invention other possibilities are given, which are not listed in detail, here. However, it is always essential that an elastic fastening element is provided to be inserted in a bore with the fastening element and perhaps also the work piece being be only elastically deformed when inserted. Therefore, a form-fitting connection always develops, which is constantly maintained due to the elastic effect.

1. A fastening element to be inserted into an opening, the fastening element comprising a shaft, having at least one of a roughened or profiled surface that is insertable into the opening, with the fastening element (1) comprising an elastically deformable material, and the shaft (5) is elastically deformable for insertion into the opening (2).

2. A fastening element according to claim 1, further comprising a stop collar (6).

3. A fastening element according to claim 1, wherein the elastically deformable material of the fastening element comprises a fiber reinforced elastically deformable material.

4. A fastening element according to claim 1, wherein the fastening element consists of the elastically deformable material.

5. A fastening element according to claim 1, wherein the elastically deformable material of the fastening element comprises a plastic.

6. A fastening element according to claim 1, wherein the shaft has as a solid profile.

7. A fastening element according to claim 1, wherein the shaft (5) has a tubular profile.

8. A fastening element according to claim 1, further comprising at least one of ribs (8, 9), grooves, knobs, corrugations, or teeth located on an exterior surface (4) of the shaft (5).

9. A fastening element according to claim 1, further comprising ribs (8) extending on an exterior surface (4) of the shaft (5) at least approximately parallel to a central axis of the shaft (5) having grooves (10) or corrugations extending generally perpendicular thereto to form a type of gearing.

10. A fastening element according to claim 8, wherein the ribs (8, 9), knobs, corrugations or teeth protrude different distances in a radial direction.

11. A fastening element according to claim 10, wherein the ribs include one or more narrow ribs (8) each following one or more wider ribs (9) alternating about a circumference of the shaft (5).

12. A fastening element according to claim 11, wherein at least one of the narrow or wide ribs is provided with teeth or corrugations.

13. A fastening element according to claim 1, further comprising a plurality of ribs (9) on the shaft aligned parallel to an axis thereof, with ribs being provided extending between some of the ribs (8) in a circumferential direction of the shaft.

14. A fastening element according to claim 1, further comprising knobs located on the shaft comprising at least one of pyramidal elements, cone-shape elements or faceted or round frustums.

15. A fastening element according to claim 8, wherein the at least one of the ribs (8, 9), grooves, knobs, corrugations, or teeth taper towards an end of the shaft at an acute angle, at least at the end region of the shaft (5).

16. A fastening element according to claim 8, further comprising at least one of a circular groove or notch on the shaft (5), in addition to the at least one of the ribs (8, 9), grooves, knobs, corrugations, or teeth, with a diameter at a bottom of the at least one of a circular groove or notch being smaller than a diameter of the opening (2) in the work piece (3) into which the shaft (5) is to be inserted.

17. A fastening element according to claim 2, further comprising a cage-like holder (12) following the stop collar (6) to accept a threaded nut or a bolt head.

18. A fastening element according to claim 2, further comprising a threaded sheath following in one piece from the stop collar (6) at a side opposite the shaft (5).

19. A fastening element according to 2, further comprising a bolt (13) that follows in one piece with the stop collar (6) on a side opposite the shaft (5), the bolt (13) is aligned with an axis of the shaft (5).

20. A fastening element according to claim 2, further comprising a threaded bolt that follows in one piece with the stop collar (6) on a side opposite the shaft (5), the threaded bolt is aligned with an axis of the shaft (5).
